(19) United States
(12) Patent Application Publication
(10) Pub. No.: US 2009/0141049 A1
(43) Pub. Date: Jun. 4, 2009

(54) DISPLAY APPARATUS FOR COMPENSATING OPTICAL PARAMETER USING FORWARD VOLTAGE OF LED AND METHOD THEREOF

(75) Inventors: Tae-hyeun Ha, Suwon-si (KR); Rustam Abdulaev, Suwon-si (KR); Hoon Choi, Hwaseong-si (KR); Hyung-rae Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/132,336

(22) Filed: Jun. 3, 2008

(30) Foreign Application Priority Data
Dec. 4, 2007 (KR) 10-2007-0125108

(51) Int. Cl. G09G 5/10

(52) U.S. Cl. 345/690

(57) ABSTRACT

A display apparatus for compensating an optical parameter, and a display method thereof are disclosed, the display apparatus including a display, an optical source unit, a voltage detection unit which measures the forward voltage of an optical source, and a control unit which controls driving of the optical source unit using a forward voltage of the at least one optical source. Accordingly, the variation of optical parameter is accurately compensated, and the cost for fabricating a temperature sensor and the time for measuring the temperature are reduced.

### CROSS-REFERENCE TO RELATED APPLICATIONS

This application claims priority from Korean Patent Application No. 10-2007-0125108, filed on Dec. 4, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to a display, and more particularly, to a display apparatus for compensating optical parameters of an optical source according to a temperature variation and a method thereof.

2. Description of the Related Art

A display apparatus converts an input video signal into a video which is invisible to the naked eye, and displays the video. Examples of a display apparatus include a cathode ray tube (CRT), liquid crystal display (LCD), or plasma display panel (PDP).

For example, a display apparatus having the LCD panel includes an optical source module to display a video using rays of light which are emitted on a liquid crystal element of the LCD panel, and which is penetrated or reflected through the liquid crystal element.

A cold cathode fluorescent lamp (CCFL) has been used as an optical source of the optical source module. However, the CCFL has problems such as short period of lifetime and deteriorated luminance.

Recently, a light emitting diode (LED) is used as an optical source of the optical source module so that the color reproduction is enhanced, and the lifetime is extended without sacrificing high luminance and luminance uniformity.

When the LED is used as an optical source, the LED is superior to the CCFL in that it maintains good color reproduction and luminance, luminance uniformity, and long period of lifetime, but the LED is inferior to the CCFL in that operation thereof is sensitive to the temperature variation due to the temperature characteristics based on P-type and N-type semiconductors (P/N) junction.

That is, the change of temperature of the LED causes turn-on voltage to be changed, and subsequently, the forward voltage is changed, changing optical parameters such as luminance and color coordination.

When the LED is used as an optical source, various methods are provided to compensate for the variation of the optical parameters according to the temperature variation.

One exemplary method employs a temperature sensor to measure the temperature of the LED; outputs the voltage corresponding to the temperature of the LED; and changes and provides the voltage to be input to the LED using the output voltage in order to compensate for the changes in the optical parameters of the LED.

However, as a general temperature sensor is disposed on a side surface of a display panel, the temperature sensor is generally arranged apart from an LED at a predetermined interval, and measures the temperature of the LED at a predetermined distance. Accordingly, the temperature measured by the temperature sensor does not correspond to the temperature of the LED, because the temperature is averaged according to the distances between the sensor and the LED. Thus, when the optical parameter is compensated using the above method, the accuracy of the compensation is degraded.

When a plurality of LEDs for outputting red, green, and blue rays are used, the optical parameters of LEDs are not compensated accurately since the discrepancies in exothermic temperatures of the LEDs and the movement of spectrum according to the temperature are not taken into account.

A plurality of temperature sensors may be included in the optical module to sense the temperature of the LEDs according to each area or each color. However, cost for fabricating the optical module and optical module is increased due to the increased number of the components.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a method for driving an optical source in order to compensate the variation of optical output according to the temperature variation using the forward voltage of the optical source varied according to the temperature variation.

According to an exemplary aspect of the present invention, there is provided a display apparatus, including a display; an optical source unit which scans a ray of light emitted from at least one optical source onto the display; and a control unit which controls driving of the optical source unit using a forward voltage of the at least one optical source.

The control unit may control the driving of the optical source unit to compensate a parameter of the optical source using the forward voltage of the at least one optical source.

The parameter of the optical source may include at least one of color, luminance, color uniformity, and brightness uniformity of the light.

The control unit may transmit a pulse width modulation (PWM) signal of the at least one optical source to the optical source unit, and control the driving of the optical source unit according to the transmitted PWM signal.

The control unit may compensate the PWM signal using the forward voltage, and transmit the compensated PWM signal to the optical source unit to control the driving of the optical source unit.

A voltage drop of the forward voltage of the at least one optical source may be proportional to a temperature variation of the at least one optical source.

The optical source may be an LED.

The apparatus may further include a voltage detection unit which measures the forward voltage of the at least one optical source, wherein the voltage detection unit may include a low pass filter (LPF) which filters out a noise of a signal received from the optical source; and a differential amplifier (DA) which amplifies the signal received from the optical source.

According to an exemplary aspect of the present invention, there is provided a display method, including scanning a ray of light emitted from at least one of optical sources on the display; and controlling emission of the optical source unit using a forward voltage of the at least one optical source.

The controlling the emission of the optical source unit may control the emission of the optical source unit to compensate a parameter of the optical source using the forward voltage of the at least one optical source.

The parameter of the optical source may include at least one of color, luminance, color uniformity, and brightness uniformity of the light.

The controlling the emission of the optical source unit may include transmitting a PWM signal of the at least one optical source to the optical source unit, and controlling the emitting of the optical source unit according to the transmitted PWM signal.

The controlling the emission of the optical source unit may compensate the PWM signal using the forward voltage, and transmit the compensated PWM signal to the optical source unit to control the emitting of the optical source unit.

A voltage drop of the forward voltage of the at least one optical source may be proportional to a temperature variation of the at least one optical source.

The optical source may be an LED.

The controlling the emission of the optical source unit may further comprise filtering out a noise of a signal of the forward voltage received from the optical source, amplifying the filtered signal, digitizing the amplified signal, and measuring the forward voltage.

### BRIEF DESCRIPTION OF THE DRAWINGS

The above and other aspects of the present invention will become more apparent by describing in detail exemplary embodiments of the present invention with reference to the accompanying drawings, in which:

FIG. 1 is a block diagram illustrating a broadcast receiving apparatus according to an exemplary embodiment of the present invention;

FIG. 2 is a block diagram illustrating a video output unit;

FIGS. 3A to 3C are views provided to explain a forward voltage drop according to the temperature variation of each LED;

FIG. 4 is a view provided to explain the relationship between the temperature of LED and an optical output efficiency;

FIGS. 5A to 5D are views provided to explain the movement of a spectrum of rays emitted from an optical source according to the temperature variation;

FIG. 6 is a block diagram illustrating a voltage detection unit;

FIG. 7 is a flowchart illustrating a voltage detection unit;

FIG. 8 is a graph comparing the forward voltage with a PWM signal; and

FIG. 9 is a flowchart provided to explain a display method according to an exemplary embodiment of the present invention.

### DETAILED DESCRIPTION OF EXEMPLARY EMBODIMENTS OF THE INVENTION

Exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

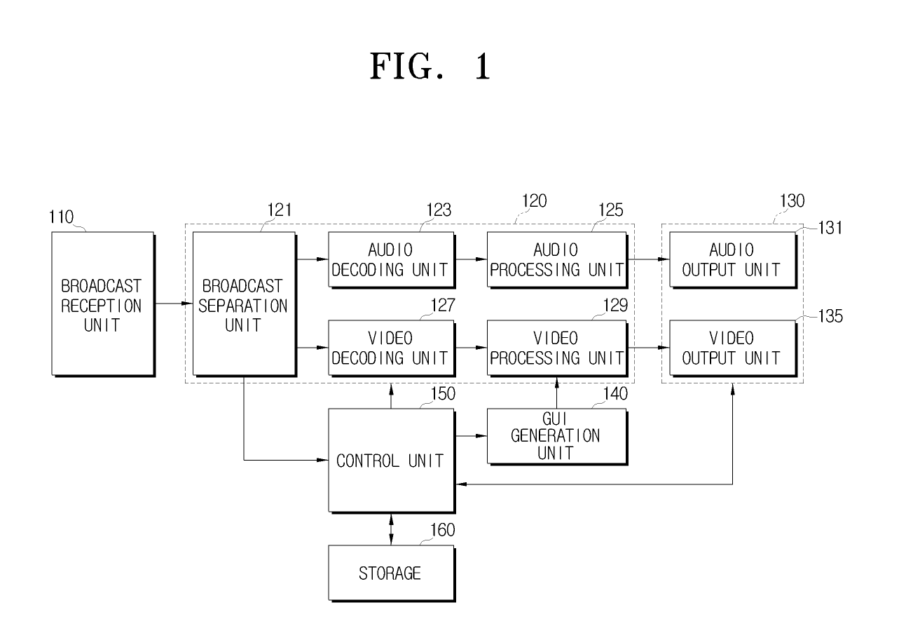

FIG. 1 is a block diagram illustrating a broadcast receiving apparatus according to an exemplary embodiment of the present invention.

A broadcast receiving apparatus 100 according to an exemplary embodiment of the present invention receives a broadcast, and provides a user with a video.

Referring to FIG. 1, the broadcast receiving apparatus 100 may include a broadcast reception unit 110, a broadcast processing unit 120, a broadcast output unit 130, a graphical user interface (GUI) generation unit 140, a control unit 150, and a storage 160.

The broadcast reception unit 110 tunes to a channel of the broadcast which is received over wire or wirelessly, and demodulates a signal of the tuned broadcast.

The broadcast processing unit 120 processes a broadcast signal output from the broadcast reception unit 110. The broadcast processing unit 120 may include a broadcast separation unit 121, an audio decoding unit 123, an audio processing unit 125, a video decoding unit 127, and a video processing unit 129.

The broadcast separation unit 121 separates a broadcast signal output from the broadcast reception unit 110 into a video signal and an audio signal, and outputs the separated signals.

The audio decoding unit 123 decodes an audio signal output from the broadcast separation unit 121. Accordingly, the audio decoding unit 123 outputs a decompressed audio signal.

The audio processing unit 125 converts a decoded audio signal into an audio signal which is capable of being output through a speaker provided to the broadcast receiving apparatus 100.

The video decoding unit 127 decodes a video signal output from the broadcast separation unit 121. Accordingly, the video decoding unit 127 outputs a decompressed video signal.

The video processing unit 129 converts a decoded video signal into a video signal which is capable of being output through the video output unit 135, and outputs the video to the video output unit 135. The video processing unit 129 processes the decoded video signal in a manner of a color signal processing and scaling.

The GUI generation unit 140 generates a GUI to be displayed on a display. The GUI generated by the GUI generation unit 140 is transferred to the video processing unit 129, and combined with a video to be displayed on the display, which is known as an on screen display (OSD) processing.

The storage 160 stores application programs which control overall driving of a display, and various data which are generated while the display is driven. The storage 160 may be implemented as a non-volatile memory such as an electrically erasable programmable read-only memory (EEPROM).

The broadcast output unit 130 outputs a video and audio corresponding to the video signal and audio signal output from the broadcast processing unit 120 to provide a user with the video and audio. The broadcast output unit 130 may comprise an audio output unit 131 and a video output unit 135.

The audio output unit 131 outputs an audio signal output from the audio processing unit 125 through a speaker.

The video output unit 135 outputs a video signal output from the video processing unit 129 through a display, which will be explained below.

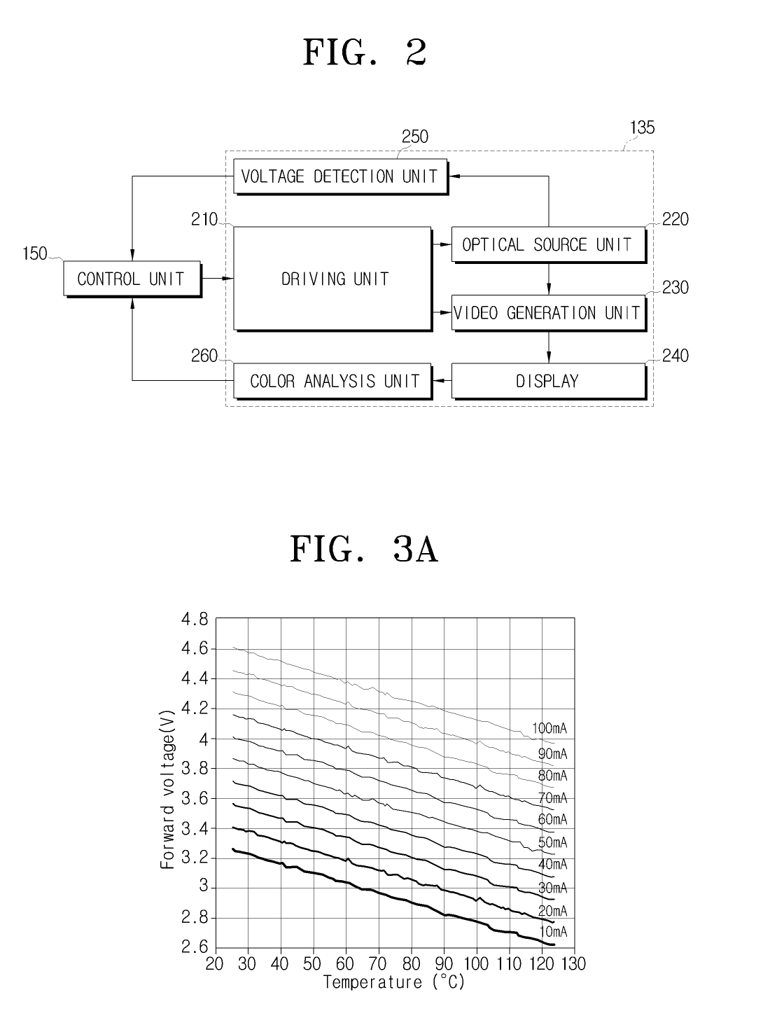

Hereinbelow, the operational process of the video output unit 135 will be explained in detail with reference to FIG. 2.

FIG. 2 is a block diagram illustrating a video output unit, in which the control unit 150 is illustrated in connection with the video output unit 135 for a convenient description. The video output unit 135 uses three LEDs, that is, red (R) LED, green (G) LED, and blue (B) LED as an optical source. The video output unit 135 transmits to the control unit 150 a signal to compensate the variation of optical parameter according to the temperature variation of the LEDs.

Referring to FIG. 2, the video output unit 135 may comprise a driving unit 210, an optical source unit 220, a video generation unit 230, a display 240, a voltage detection unit 250, and a color analysis unit 260.

The driving unit 210 generates a driving signal to drive the display 240, and outputs the generated driving signal to the optical source unit 220 and the video generation unit 230.

The optical source unit 220 comprises a R-LED, G-LED, and B-LED. The LEDs generate and scan red, green, and blue rays, respectively.

The optical source unit 220 sequentially generates and scans R, G, and B rays. If the video output unit 135 adopts the National Television System Committee (NTSC) standard, the optical source unit 220 scans R-ray for 1/180 second, that is ⅓ of a frame period, G-ray for 1/180 second, B-ray for 1/180 second, R-rays for 1/180 second, . . . , and B-ray for 1/180 second, so the R, G, and B rays are sequentially scanned. Alternatively, the video output unit 135 adopts the Phase Alternating Line (PAL) standard, the optical source unit 220 sequentially scans R, G, and B rays per 1/150 second, respectively.

The R, G, and B LEDs of the optical source unit 220 may be connected with each driving unit 210, or a plurality of R, G, and B LEDs within a block may be connected with each driving unit 210. The fewer LEDs that are connected with each driving unit 210, the more accurately optical parameter is compensated.

The forward voltage drop of the LEDs of the optical source unit 220 is increased in connection with the temperature rise of the LEDs. That is, if the temperature of the LEDs of the optical source unit 220 is increased, the forward voltage of the LEDs is decreased. The reduction of the forward voltage is varied according to a type of LEDs.

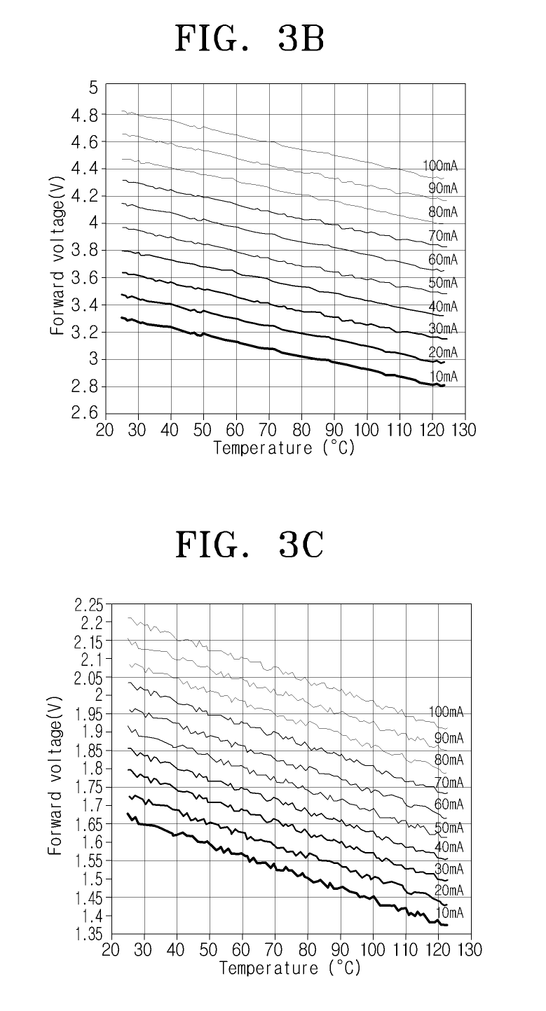

FIGS. 3A to 3C are graphs provided to explain a forward voltage drop according to the temperature variation of each LED. More specifically, FIGS. 3A to 3C illustrate the relationship between the temperature variation and forward voltage drop, in which the temperature is measured using B-LED using gallium indium phosphide (GaInN), G-LED using GaInN, and R-LED using aluminum gallium indium phosphide (AlGaInP), respectively.

Referring to FIGS. 3A to 3C, when the current flows uniformly, the forward voltage of LED is varied according to a type and temperature of LEDs. That is, if the current is applied to the LED at a constant level ranging from 10 mA to 100 mA, the temperature of the LED is raised, so the forward voltage drop occurs across the LED.

The forward voltage of LED is estimated according to Formula 1.

$${V}_{f} = \frac{k T \cdot ln ( {I}_{F} / {I}_{S} )}{q} , \qquad [ Formula 1 ]$$

where

V_{f}=forward voltage

k=boltzmann constant

T=absolute temperature

q=electron charge

I_{F}=forward current

I_{S}=saturation current

If the forward current and saturation current are constant, the corresponding temperature may be estimated with reference to the forward voltage.

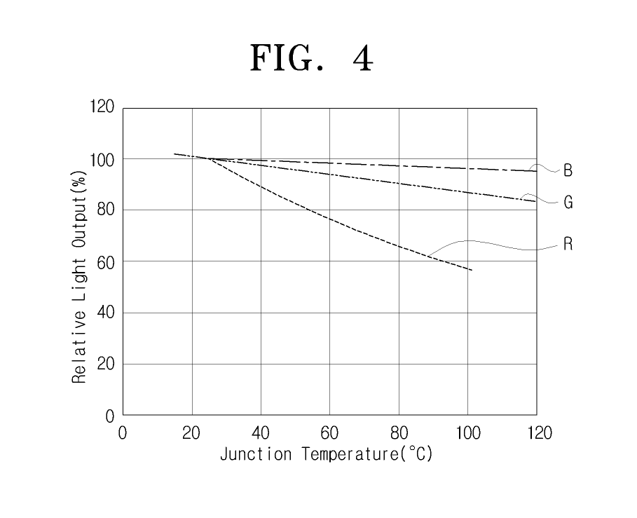

The temperature of LED is related with an optical output efficiency. FIG. 4 is a view provided to explain the relationship between the temperature of LED and an optical output efficiency.

Referring to FIG. 4, an optical output efficiency of an optical source outputting rays of each color deteriorates according to the temperature rise. Specifically, the optical output efficiency of the LED emitting R-ray is reduced more significantly than the optical output efficiency of the LEDs emitting G and B rays.

Accordingly, the relationship between the optical output efficiency and the temperature is linearly varied as illustrated in FIG. 4.

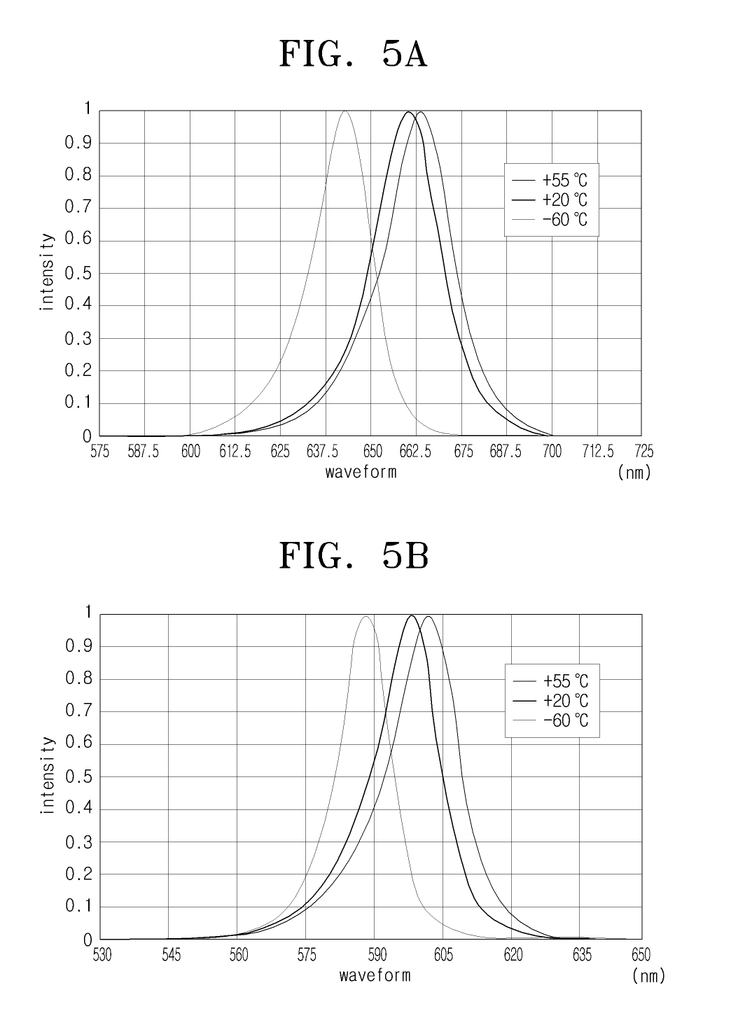

The temperature of an LED moves a spectrum of rays emitted from an optical source. FIGS. 5A to 5D are graphs provided to explain movement of a spectrum of rays emitted from an optical source according to the temperature variation. More specifically, FIGS. 5A to 5D illustrate the movement of a spectrum of rays output when the temperature of optical sources emitting R, Yellow (Y), G, and B rays is varied, respectively.

Referring to FIGS. 5A to 5D, a spectrum of light output from an optical source of each color varies according to the temperature variation. The peak frequency and peak amplitude of LED emitting R-ray of FIG. 5A varies more than those of G, and B rays of FIGS. 5C and 5D.

Referring to FIGS. 3A to 4, the temperature variation of LED, voltage drop of LED, and optical output variation rate are proportional to each other, and referring to FIGS. 5A to 5D, the temperature variation of LED is related with the movement of spectrum.

To drive an optical source by compensating the variation of an optical parameter according to the temperature variation, the voltage drop in proportion to the temperature of LED may be used.

In an exemplary embodiment of the present invention, the driving of an optical source is controlled with reference to the relationship between the temperature variation and forward voltage drop to consider the temperature variation as described above, so that the optical output efficiency and the movement of optical spectrum is compensated. More detailed description will be explained below with reference to FIG. 2.

Referring to FIG. 2, the optical source unit 220 transmits to the video generation unit 230 the R, G, and B rays, being scanned from R, G, and B LEDs and passing through an optical filter (not shown), and transmits the voltage output from the R, G, and B LEDs to the voltage detection unit 250.

The driving unit 210 drives the video generation unit 230. The video generation unit 230 demodulates the incident R, G, and B rays, and projects a generated video on the display 240. More specifically, the video generation unit 230 adjusts the reflection angle of the incident R, G, and B rays according to pixels, and projects a video on the display 240.

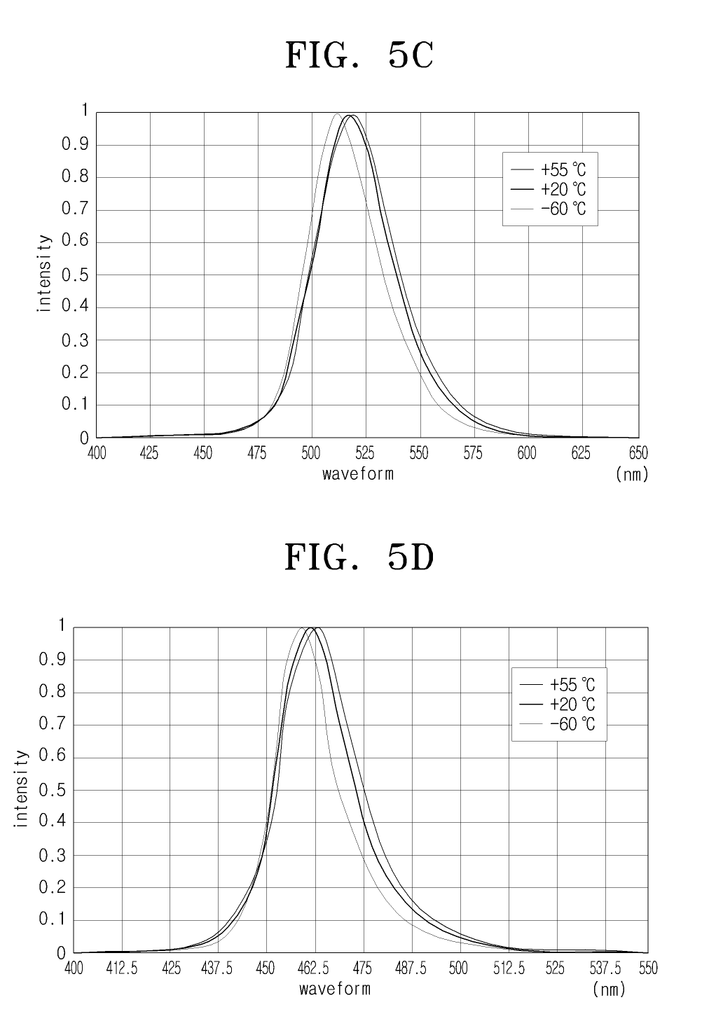

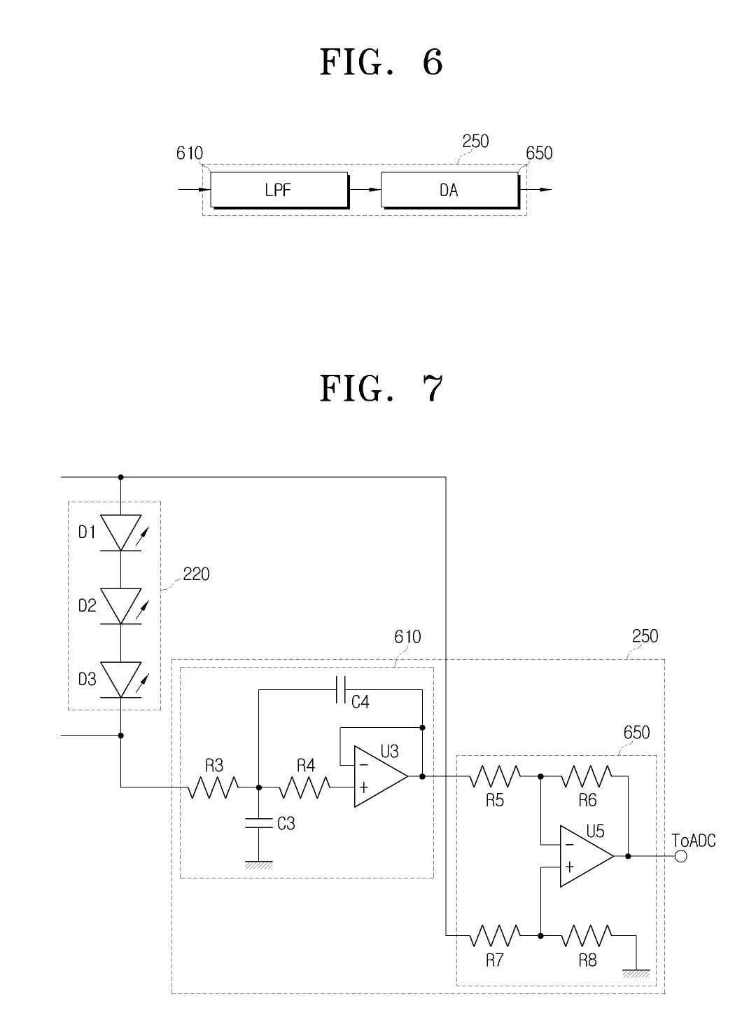

The voltage detection unit 250 receives the voltage output from the R, G, and B LEDs, and estimates the forward voltage drop occurring across the LEDs, respectively. The operations of the voltage detection unit 250 will be explained in detail with reference to FIGS. 6 and 7.

FIG. 6 is a block diagram illustrating the voltage detection unit, and FIG. 7 is a flowchart illustrating the voltage detection unit. The voltage detection unit 250 may comprise an LPF 610, and a DA 650.

The forward voltage supplied to LEDs (D1, D2, D3) of the optical source unit 220 decreases according to the temperature rise of the LEDs (D1, D2, D3) as described in FIGS. 3A to 3B.

The LPF receives the output voltage of the LEDs (D1, D2, D3), filters out a PWM noise of the output voltage, and outputs the filtered voltage to the DA 650.

The DA 650 receives the output voltage filtering the PWM noise from the LPF 610, amplifies the received output voltage, and outputs the amplified output voltage to the control unit 150. The DA 650 is used to amplify a preorder level of a PWM signal.

As the output voltage amplified by the DA 650 is generated based on the forward voltage variation according to the temperature variation of LED, the output voltage may have various levels corresponding to each temperature.

The DA 650 outputs to an analog to digital converter (ADC) the output voltage of the preorder level corresponding to the temperature variation, that is corresponding to each temperature output according to the temperature variation of LED, and the ADC digitizes the output voltage of the preorder level. The ADC may be comprised in the control unit 150 in FIGS. 1 and 2, or may be formed independently from the control unit 150.

The display 240 displays the video projected by the video generation unit 230 to provide a user with the video.

The color analysis unit 260 estimates an optical output rate of an optical source using rays which are output from the optical source unit 220, and projected or reflected to the display 240 passing through a diffusion film (not shown). The color analysis unit 260 provides the controller 150 with the estimated optical output rate.

The overall operations of the video output unit 135 will be described based on the control unit 150.

The control unit 150 controls overall operations of the video output unit 135.

The overall operations of the video output unit 135 including the control unit 150 are provided differently according to the time when the display 240 is driven.

When the display is initially driven, the control unit 150 generates a PWM signal having a predetermined pulse width, and outputs the generated PWM signal to the driving unit 210. After the display 240 is initially driven, the control unit 150 generates a PWM signal considering the optical output variation according to the temperature variation, and outputs the generated PWM signal to the driving unit 210.

In the operation of the initial driving of the display 240, the control unit 150 outputs a predetermined PWM signal to the driving unit 210. The predetermined PWM signal is pre-stored in the storage 160.

The control unit 150 transmits the predetermined PWM signal to the driving unit 210. The driving unit 210 generates a driving signal, and outputs the generated driving signal to the optical source unit 220, and the video generation unit 230.

The voltage detection unit 250 detects the voltage drop of LED from the optical source unit 220, and the color analysis unit 260 detects the optical output rate from the display 240.

The control unit 150 measures an optical parameter using the voltage drop of LED detected by the voltage detection unit 250 and the optical output rate of LED detected by the color analysis unit 260, and stores the measured optical parameter in the storage 160.

The control unit 150 compensates a PWM signal using the measured optical parameter, and transmits the compensated PWM signal to the driving unit 210.

If the control unit 150 outputs the compensated PWM signal to the driving unit 210 after the display 240 is initially driven, the driving unit 210 receives the PWM signal, and outputs the received PWM signal to the R, G, and B LEDs of the optical source unit 220.

Thereafter, the color analysis unit 260 does not operate, and the voltage detection unit 250 detects the voltage drop of LED from the optical source 220.

The control unit 150 compensates the PWM signal using the voltage drop of LED detected by the voltage detection unit 250 and the predetermined optical parameter stored in the storage 160, and transmits the compensated PWM signal to the driving unit 210.

Theses operations are reiterated to display a video on the display 240.

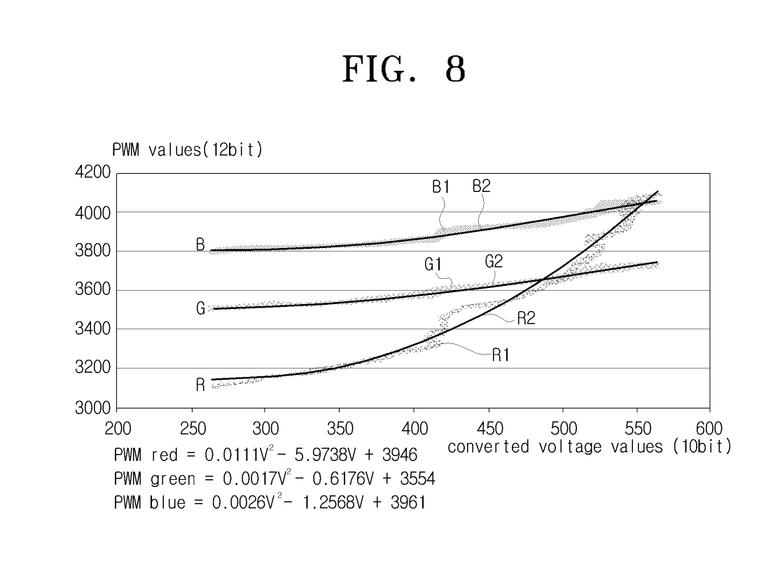

The relationship between an optical parameter signal and the forward voltage illustrated in FIG. 8 may be understood with reference to a parameter which may be predetermined when the display 240 is initially driven and stored in the storage 160, and the forward voltage which corresponds to each PWM signal is digitized.

FIG. 8 is a graph comparing the forward voltage with a PWM signal.

The graph of FIG. 8 represents the relationship between PWM signal and converted voltage values, in which the LEDs embodied by the present applicant, is under the name of SMD LEDs including type SL S101 (blue (BL), green (GR), red (RD)). The X axis represents the forward voltage of LED corresponding to the PWM signal as digital data of 10 bits, and the Y axis represents the PWM signal as data of 12 bits.

Referring to the linear relationship between the temperature of an LED and an optical output efficiency as described in FIG. 4, the measurements R1, B1, and C1 of FIG. 8 may be approximated to R2, B2, and C2 to draw Formula 2.

PWM=kₙ·V_{forward}ⁿ+ . . . +k₂·V_{forward}²+k₁·V_{forward}¹+k₀, [Formula 2]

where
kₙ, . . . , k₀=coefficient for compensating parameter decided according to measured result
V_{forward}=forward voltage

The control unit 150 estimates the coefficients of Formula 2 using the relationship between the PWM signal and the forward voltage converted to digital data. Formula 2 is pre-stored in the storage 160.

The control unit 150 compensates the variation of optical parameter of LED according to the temperature variation.

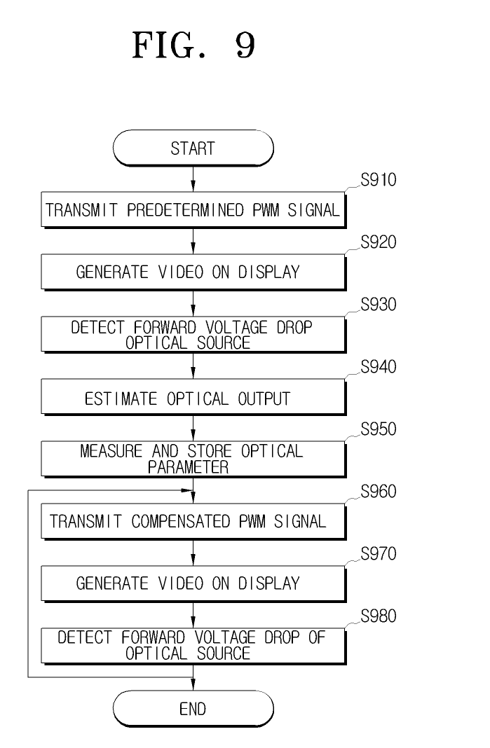

FIG. 9 is a flowchart provided to explain a display method according to an exemplary embodiment of the present invention.

The control unit 150 transmits the PWM signal in the storage 160 to the driving unit 210 (S910).

The driving unit 210 drives the optical source unit 220 and the video generation unit 230, and generates the video on the display 240 (S920).

The current flows through the LED of the optical source 200 by generating the video. The voltage detection unit 250 detects the forward voltage drop of LED of the optical source unit 220 (S930).

The color analysis unit 260 estimates an optical output rate of an LED using rays which are output from the optical source unit 220, and projected or reflected to the display 240 passing through a diffusion film (not shown) (S940).

The control unit 150 measures an optical parameter using the voltage drop of LED detected by the voltage detection unit 250 and the optical output rate of an LED detected by the color analysis unit 260, and stores the measured optical parameter in the storage 160 (S950).

The control unit 150 compensates the PWM signal using the predetermined optical parameter, and transmits the compensated PWM signal to the driving unit 210 (S960).

The driving unit 210 drives the optical source unit 220 and the video generation unit 230, and generates the video on the display 240 (S970).

While the video is generated, the voltage detection unit 250 detects again the forward voltage drop of LEDs of the optical source unit 220 (S980).

If operation S980 is completed, the operation returns to operation S960, and operations S960 to S980 are reiterated, so the parameter of optical sources is compensated.

The implementation of the display apparatus, which is the video output unit, as a component of a broadcast receiving apparatus in an exemplary embodiment of the present invention should not be considered limiting. Alternatively, the display apparatus may be implemented for other apparatuses and systems instead of the broadcast receiving apparatus.

While a display apparatus and display method are described for compensating optical parameter of an LED using a PWM signal according to a PWM method, the display apparatus and display method may be embodied using various methods including a linear control method in addition to the PWM method.

The display apparatus may depend on other apparatuses and systems, and may be used independently.

The voltage detection unit is implemented separately from the color analysis unit, but it is merely an exemplary embodiment of the present invention for a convenient description. The voltage detection unit and color analysis unit may be included in the control unit.

The graphs of FIGS. 3A to 5D, and FIG. 8 are constructed when specific LEDs are used for this exemplary embodiment of the present invention. However, a type of LEDs is not considered limiting for the exemplary embodiment of the present invention.

According to the above exemplary embodiments of the present invention, the temperature variation of optical source are estimated using the variation of the forward voltage varied according to the temperature variation of LED used as an optical source. Therefore, the variation of optical parameter of LEDs according to each color is accurately compensated, and the cost for implementing an additional temperature sensor is reduced. As the temperature characteristics of LED is used, the temperature of LED is measured, and the time delay occurring when measuring the temperature is reduced.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
a display;
an optical source unit which scans a ray of light emitted from at least one optical source onto the display; and
a control unit which controls driving of the optical source unit using a forward voltage of the at least one optical source.

2. The apparatus of claim 1, wherein the control unit controls the driving of the optical source unit to compensate a parameter of the optical source using the forward voltage of the at least one optical source.

3. The apparatus of claim 2, wherein the parameter of the optical source comprises at least one of color, luminance, color uniformity, and brightness uniformity of the light.

4. The apparatus of claim 1, wherein the control unit transmits a pulse width modulation (PWM) signal of the at least one optical source to the optical source unit, and
controls the driving of the optical source unit according to the transmitted PWM signal.

5. The apparatus of claim 4, wherein the control unit compensates the PWM signal using the forward voltage, and transmits the compensated PWM signal to the optical source unit to control the driving of the optical source unit.

6. The apparatus of claim 1, wherein a voltage drop of the forward voltage of the at least one optical source is proportional to a temperature variation of the at least one optical source.

7. The apparatus of claim 1, wherein the optical source is a light emitting diode (LED).

8. The apparatus of claim 1, further comprising:
a voltage detection unit which measures the forward voltage of the at least one optical source,
wherein the voltage detection unit comprises:
a low pass filter which filters noise from a signal received from the at least one optical source; and
a differential amplifier which amplifies the signal received from the at least one optical source.

9. The apparatus of claim 1, wherein the optical source comprises:
a red light emitting diode (LED);
a green LED; and
a blue LED.

10. The apparatus of claim 1, further comprising:
a color analysis unit which estimates an optical output rate of a light emitting diode using rays which are output from the optical source unit, and projected to the display passing through a diffusion film.

11. A display method comprising:
scanning a ray of light emitted from at least one optical source on a display; and
controlling emission of an optical source unit using a forward voltage of the at least one optical source.

12. The method of claim 11, wherein the controlling the emission of the optical source unit compensates a parameter of the optical source using the forward voltage of the at least one optical source.

13. The method of claim 12, wherein the parameter of the optical source comprises at least one of color, luminance, color uniformity, and brightness uniformity of the light.

14. The method of claim 11, wherein the controlling the emission of the optical source unit comprises:
transmitting a pulse width modulation (PWM) signal of the at least one optical source to the optical source unit; and
controlling the emission of the optical source unit according to the transmitted PWM signal.

15. The method of claim 14, wherein the controlling the emission of the optical source unit comprises:
compensating the PWM signal using the forward voltage; and
transmitting the compensated PWM signal to the optical source unit to control the emission of the optical source unit.

16. The method of claim 11, wherein a voltage drop of the forward voltage of the at least one optical source is proportional to a temperature variation of the at least one optical source.

17. The method of claim 11, wherein the optical source is a light emitting diode.

18. The method of claim 11, wherein the controlling the emission of the optical source unit comprises:
filtering noise from a signal of the forward voltage received from the optical source;
amplifying the filtered signal;
digitizing the amplified signal; and
measuring the forward voltage.

19. The method of claim 11, wherein the optical source comprises:
a red light emitting diode (LED);
a green LED; and
a blue LED.

20. The method of claim 11, wherein the controlling the emission of the optical source unit further comprises:
estimating an optical output rate of a light emitting diode using rays output from the optical source unit; and
projecting to the display passing through a diffusion film.
